(19) United States
(12) Patent Application Publication
(10) Pub. No.: US 2012/0025579 A1
(43) Pub. Date: Feb. 2, 2012

(54) VEHICLE SEAT

(75) Inventors: Tatsuya ONO, Toyota-shi (JP); Yuichi MATSUI, Owariasahi-shi (JP); Yukinori SUGIURA, Nissin-shi (JP); Yoshiro HARA, Ichinomiya-shi (JP); Takashi OKADA, Toyota-shi (JP)

(73) Assignee: TOYOTA BOSHOKU KABUSHIKI KAISHA, Aichi-ken (JP)

(21) Appl. No.: 13/187,908

(22) Filed: Jul. 21, 2011

(30) Foreign Application Priority Data
Jul. 29, 2010 (JP) 2010-170309

(51) Int. Cl. B60N 2/20; B60N 2/22; B60N 2/68

(52) U.S. Cl. 297/354.1; 297/452.18

(57) ABSTRACT

A vehicle seat includes a back frame including: a back frame body that is formed by bending a pipe into a rectangular form such that both ends of the pipe are located at one of four corner portions of the rectangular form; and a pair of side frames that are joined, respectively, to a first corner portion which is one of the corner portions of the back frame body and at which the both ends of the pipe are located and a second corner portion that is another of the corner portions of the back frame body and is laterally next to the first corner portion. One of the ends of the pipe is butt-welded to one of the side frames.

### INCORPORATION BY REFERENCE

The disclosure of Japanese Patent Application No. 2010-170309 filed on Jul. 29, 2010 including the specification, drawings and abstract is incorporated herein by reference in its entirety.

### BACKGROUND OF THE INVENTION

1. Field of the Invention

The invention relates to a vehicle seat. In particular, the invention relates to a vehicle seat that includes a back frame including a back frame body that is formed by bending a pipe into a rectangular form and a pair of side frames that are joined to the back frame body.

2. Description of Related Art

A vehicle seat known in related art includes a back frame body that is formed by bending a pipe into a rectangular form. Japanese Patent Application Publication No. 07-47021 (JP 07-47021 A) describes a vehicle seat having such a rectangular back frame body of which the lower-left corner portion and lower-right corner portion, among its four corner portions, are welded, respectively, to paired side frames. With this structure, the side frames may be pivotally attached to a cushion frame of a seat cushion. Thus, even if a simply-structured back frame body formed by bending a pipe into a rectangular form is used, a seatback is reclinable relative to the seat cushion.

### SUMMARY OF THE INVENTION

According to the related art described above, among both end portions of the pipe, an end portion of a portion of the pipe, which is at the base side (lower side) of the back frame body and which extends from a lower left portion to a lower right portion of the back frame body, is bent into a substantially L-shape and then welded to one of the side frames. Therefore, the lateral strength of the back frame body at the base side (lower side) is low, which makes it difficult for the back frame body to withstand impacts caused by a side collision of the vehicle.

The invention provides a vehicle seat that includes a back frame body that is simply-structured but is able to withstand impacts caused by a side collision of a vehicle.

An aspect of the invention relates to a vehicle seat that includes a back frame including: a back frame body that is formed by bending a pipe into a rectangular form such that both ends of the pipe are located at one of four corner portions of the rectangular form; and a pair of side frames that are joined, respectively, to a first corner portion which is one of the corner portions of the back frame body and at which the both ends of the pipe are located and a second corner portion that is another of the corner portions of the back frame body and is laterally next to the first corner portion. In this vehicle seat, one of the ends of the pipe is butt-welded to one of the side frames. With this structure, the back frame body is formed by bending a pipe into a rectangular form, as in the related art. Therefore, it is possible to form the simply-structured back frame body. What is more, the number of points at which a pipe is bent to form the back frame body is smaller than that in the related art (a pipe needs to be bent at four points in the related art, whereas a pipe needs to be bent at only three points according to the invention). Therefore, the back frame body of the vehicle seat described above is simpler in structure than that in the related art. In the structure described above, the one of the both ends of the pipe that forms the back frame body is welded to the inner face of the one of the side frames such that the axial direction of the one of the ends is perpendicular to the principal plane of the side frame. Therefore, the lateral strength of the back frame body at the base side (lower side) is high, which makes it possible for the back frame body to withstand impacts caused by a side collision of the vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of the entirety of a frame structure inside a driver seat according to an example embodiment of the invention; and

FIG. 2 is a front view of the frame structure shown in FIG. 1.

### DETAILED DESCRIPTION OF EMBODIMENTS

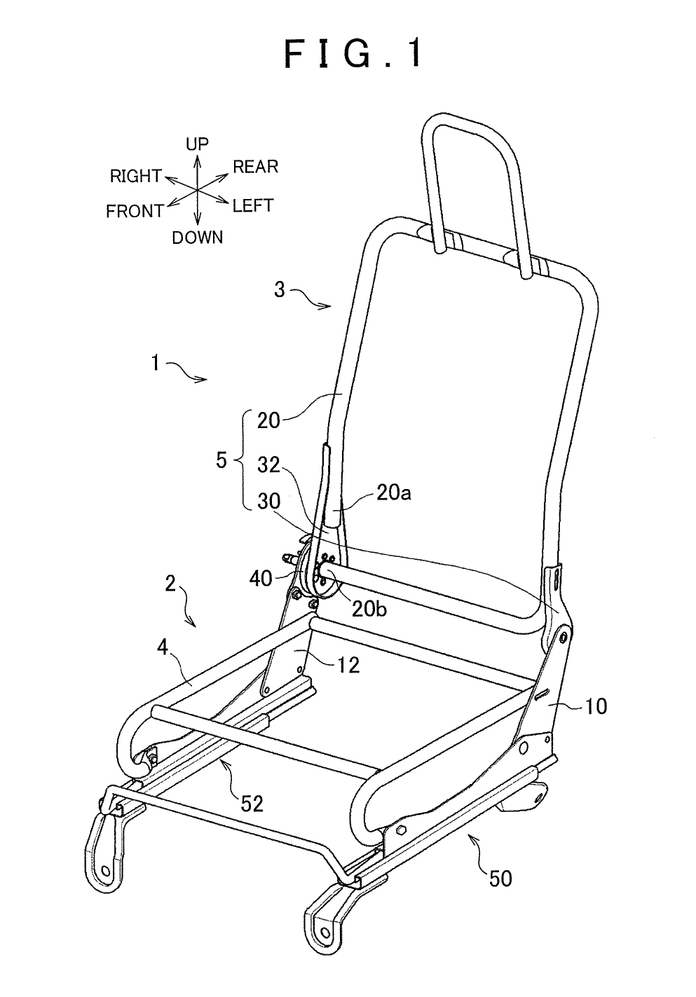

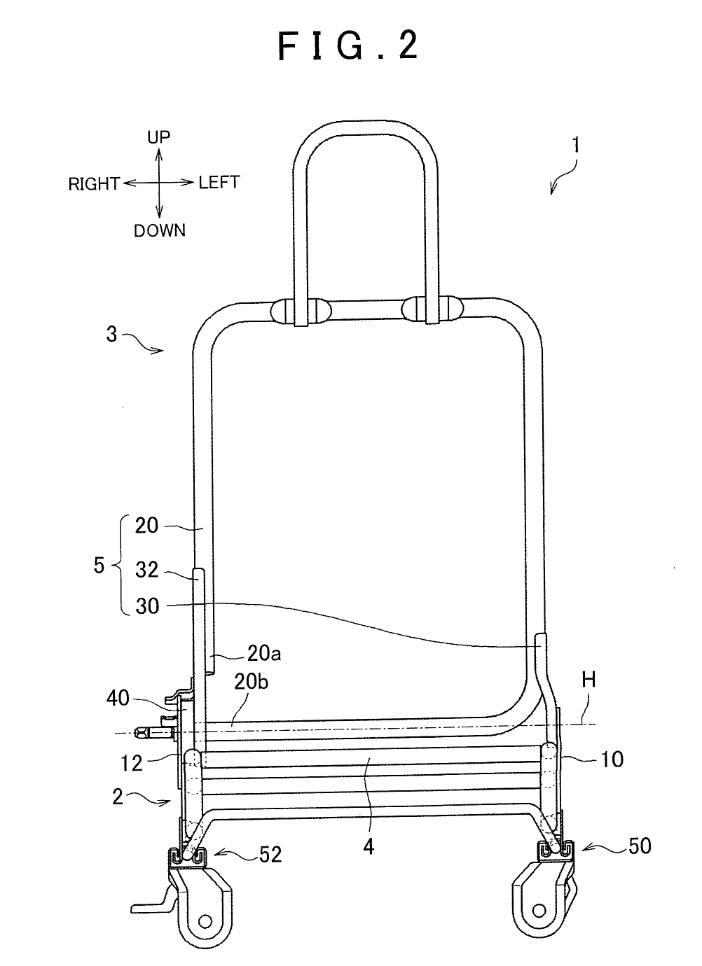

Hereinafter, an example embodiment of the invention will be described with reference to FIGS. 1 and 2. In the following, a driver seat 1 will be described as an example of “vehicle seat” according to the invention. Further, the sides and directions specified using “upper”, “lower”, “front”, “rear”, “left”, and “right” in the following descriptions shall be interpreted as corresponding, respectively, to the directions indicated by the arrows UP, DOWN, FRONT, REAR, LEFT, and RIGHT in the drawings, that is, the upward direction, downward direction, forward direction, rearward direction, left-hand direction, and right-hand direction as defined with respect to the driver seat 1.

First, the schematic structure of the driver seat 1 according to the example embodiment of the invention will be described with reference to FIG. 1. The driver seat 1 includes a seat cushion 2 and a seatback 3. The structures of the seat cushion 2 and seatback 3 will be individually described.

First, the structure of the seat cushion 2 will be described. The seat cushion 2 is constructed mainly of a cushion frame 4 that has a generally rectangular form, a known cushion pad (not shown in the drawings) that is fitted to the cushion frame 4 such that the cushion frame 4 is embedded in the cushion pad, and a known seat cover (not shown in the drawings) that covers the surfaces of the cushion pad.

The cushion frame 4 is fitted, at its lower-left and lower-right portions, to a vehicle floor (not shown in the drawings) via slide rails 50 and 52 each having a known structure that allows an upper rail to slide relative to a lower rail. Thus, the driver seat 1 is slidable in the longitudinal direction of the vehicle floor.

A lower arm 10 is provided between and fitted to a left rear end of the cushion frame 4 and (the upper rail of) the left slide rail 50, while a lower arm 12 is provided between and fitted to a right rear end of the cushion frame 4 and (the upper rail of) the right slide rail 52. With this structure, a back frame 5 of the seatback 3, which will be described later, may be attached to the cushion frame 4. This is how the seat cushion 2 is structured.

Next, the structure of the seatback 3 will be described. Like the seat cushion 2 described above, the seatback 3 is mainly constructed of the back frame 5 that has a generally rectangular form, a known cushion pad (not shown in the drawings) that is fitted to the back frame 5 such that the back frame 5 is embedded in the cushion pad, and a known seat cover (not shown in the drawings) that covers the surfaces of the cushion pad.

In the following, the back frame 5 will be described in detail. The back frame 5 is constructed of a back frame body 20, a left side frame 30, and a right side frame 32, which will be individually described below.

First, the back frame body 20 will be described. The back frame body 20 is a frame member that forms a framework of the back frame 5, and is formed by bending, at three points, a round cylindrical pipe into a generally rectangular form. The round pipe is bent such that both ends thereof are located at a lower-right corner portion of the back frame body 20. This is how the back frame body 20 is structured.

Next, the left side frame 30 and the right side frame 32 will be described. First, the left side frame 30 will be described. The left side frame 30 is a bracket used to connect a left side portion of the back frame body 20 to a left side portion of the cushion frame 4 such that these left side portions are aligned with each other. Therefore, a laterally outer side portion of a lower-left corner portion of the back frame body 20 is welded to an inner face of the left side frame 30. Note that this lower-left corner portion is an example of “second corner portion” in the invention. The left side frame 30 is pivotally attached, at its outer face, to an inner face of the lower arm 10, which is arranged on the left side of the cushion frame 4. This is how the left side frame 30 is structured.

Next, the right side frame 32 will be described. Like the left side frame 30 described above, the right side frame 32 is a bracket used to connect a right side portion of the back frame body 20 to a right side portion of the cushion frame 4. Therefore, a laterally outer side portion of the lower-right corner portion of the back frame body 20 is welded to an inner face of the right side frame 32. Note that this lower-right corner portion is an example of “first corner portion” in the invention.

The manner of joining the lower-right corner portion of the back frame body 20 to the right side frame 32 will be described in detail. The both ends of the round pipe are located at the lower-right corner portion of the back frame body 20 as mentioned above. Among the both ends of the round pipe, a first end 20a at the lower-right corner portion of the back frame body 20 is welded to the inner face of the right side frame 32 such that the axial direction of the first end 20a is parallel to a principle plane of the right side frame 32.

On the other hand, a second end 20b, which is one of the both ends of the round pipe, is welded to the inner face of the right side frame 32 such that the axial direction of the second end 20b is perpendicular to the principal plane of the right side frame 32. That is, the second end 20b of the back frame body 20 is butt-welded to the right side frame 32.

The right side frame 32 is pivotally attached, at its outer face, to an inner face of the lower arm 12, which is arranged on the right side of the cushion frame 4. A known recliner 40 is interposed between and fitted to the outer face of the right side frame 32 and the inner face of the lower arm 12. Thus, the back frame 5 may be locked at a desired tilt angle relative to the cushion frame 4. As a result, the driver seat 1 is provided with a reclining function.

The recliner 40 is fitted to the outer face of the right side frame 32 and the inner face of the right lower arm 12 such that the rotational center of the recliner 40 coincides with the axis of a portion of the round pipe that forms the back frame body 20, the portion extending toward the recliner 40 from the lower-left corner portion. The single dot chain line H in FIG. 2 indicates how they coincide with each other. This is how the right side frame 32 is structured. The seatback 3 is constructed of the back frame body 20, the left side frame 30, and the right side frame 32.

The driver seat 1 according to the example embodiment of the invention is constructed of the seat cushion 2 and the seatback 3 described above. With this structure, the back frame body 20 is formed by bending a round pipe into a rectangular form, as in the related art. Thus, the simply-structured back frame body 20 is formed. What is more, the number of points at which a round pipe is bent to form the back frame body 20 is smaller than that in the related art (a round pipe needs to be bent at four points in the related art, whereas a round pipe needs to be bent at only three points according to the invention). Therefore, the back frame body 20 is simpler in structure than the back frame body in the related art. In the structure described above, among the both ends of the round pipe, the second end 20b of the round pipe that forms the back frame body 20 is welded to the inner face of the right side frame 32 such that the axial direction of the second end 20b is perpendicular to the principal plane of the right side frame 32. Therefore, the lateral strength of a lower side portion of the back frame body 20 is high, which makes it possible for the back frame body 20 to withstand impacts caused by a side collision of the vehicle. If the back frame body 20 is formed as described above, even when load acts rearward on the back frame body 20 at a position close to a headrest, the load is distributed to the both sides of the back frame body 20, and the load distributed to each side of the back frame body 20 is transmitted to the corresponding end of the back frame body 20 (i.e., the corresponding end of the round pipe). Then, the load transmitted to each end of the back frame body 20 is transmitted to the cushion frame 4. Thus, even when load acts rearward on the back frame body 20 at a position close to the headrest, the load is smoothly transmitted toward the seat cushion 2. That is, not only the stress caused by a side collision of the vehicle but also the stress caused by load acting rearward is dispersed instead of being concentrated.

In the structure described above, the recliner 40 is fitted to the outer face of the right side frame 32 and the inner face of the right lower arm 12 such that the rotational center of the recliner 40 coincides with the axis of the portion of the round pipe that forms the back frame body 20, the portion extending toward the recliner 40 from the lower-left corner portion. Therefore, for example, even if high load acts, due to a side collision, on the back frame body 20 from the left to the right, the load is reliably released to the cushion frame 4 through the recliner 40.

While “vehicle seat” according to the invention is embodied as the driver seat 1 in the foregoing example embodiment, the invention is not limited to it. That is, for example, the invention may be as applied to a front passenger seat or a rear seat. Further, “vehicle seat” according to the invention may have a structure that is reversed left-right from that of the driver seat 1 according to the foregoing example embodiment. For example, the both ends of the round pipe that forms the back frame body may be located at the lower-left corner portion of the back frame body.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

What is claimed is:

1. A vehicle seat comprising a back frame including: a back frame body that is formed by bending a pipe into a rectangular form such that both ends of the pipe are located at one of four corner portions of the rectangular form; and a pair of side frames that are joined, respectively, to a first corner portion which is one of the corner portions of the back frame body and at which the both ends of the pipe are located and a second corner portion that is another of the corner portions of the back frame body and is laterally next to the first corner portion, wherein
one of the ends of the pipe is butt-welded to one of the side frames.

2. The vehicle seat according to claim 1, further comprising a recliner that is attached on an outer face of a portion of the one of the side frames at which said side frame is joined to the first corner portion, and that is used to recline the back frame relative to a cushion frame, wherein a rotational center of the recliner coincides with an axis of a portion of the pipe that extends toward the recliner from the second corner portion.

3. The vehicle seat according to claim 1, wherein the other end of the pipe is joined to an inner face of the one of the side frames such that an axial direction of the other end is parallel to a principal plane of the one of the side frames.

4. The vehicle seat according to claim 1, wherein the first corner portion is a corner portion at a lower side of the back frame body.
